(19) United States
(12) Patent Application Publication
(10) Pub. No.: US 2025/0323285 A1
(43) Pub. Date: Oct. 16, 2025

(54) AMPHOTERIC ION EXCHANGE SEPARATOR FOR REDOX BATTERY, METHOD FOR MANUFACTURING SAME, AND REDOX BATTERY COMPRISING SAME

(71) Applicant: DAEGU GYEONGBUK INSTITUTE OF SCIENCE AND TECHNOLOGY, Daegu (KR)

(72) Inventors: Da Bin HAN, Gwangju (KR); Shanmugam SANGARAJU, Daegu (KR)

(21) Appl. No.: 18/574,141

(22) PCT Filed: Sep. 1, 2022
(86) PCT No.: PCT/KR2022/013095

§ 371 Date: Jun. 28, 2024

(30) Foreign Application Priority Data
Sep. 3, 2021 (KR) 10-2021-0117575

(51) Int. Cl. H01M 8/0239; C08F 8/42; C08K 9/06; H01M 8/18

(52) U.S. Cl. CPC H01M 8/0239; C08F 8/42; C08K 9/06; H01M 8/188

(57) ABSTRACT

An amphoteric ion exchange separator for a redox battery according to various embodiments of the present invention may comprise a polymer matrix into which a zwitterionic functional group having a quaternary ammonium group and a sulfonic acid group is introduced.

### TECHNICAL FIELD

Embodiments relate to an amphoteric ion exchange separator for a redox battery, a method of manufacturing the same, and a redox battery including the same.

### BACKGROUND ART

As conventional power generation systems, such as thermal power generation systems, which use fossil fuels and thus cause large amounts of greenhouse gases and environmental pollution problems, and nuclear power generation systems, which have problems such as the stability of the facility and waste disposal, have various limitations, research on the development of more eco-friendly and highly efficient energy and the development of power supply systems using the same is increasing significantly.

In particular, power storage technology more diversely and widely uses renewable energy, which is greatly influenced by external conditions and increases the utilization efficiency of power and thus development is focused on this field. In particular, interest and research and development are increasing significantly on secondary batteries.

A redox battery refers to an oxidation/reduction battery that can directly convert the chemical energy of active materials into electrical energy and can store renewable energy, such as solar power and wind power, whose output is highly variable depending on the external environment, and convert the renewable energy into high-quality power. Recently, such a redox battery has attracted attention due to the potentially low cost thereof as well as the stability, scalability, power and energy capacity thereof. A Zn—Br battery is an aqueous redox battery, which has a much cheaper redox couple material than a vanadium redox battery, which is widely known as a vanadium redox flow battery, produces a voltage of 1.8 V or more and thus has high output. In addition, the Zn—Br battery has an advantage of high energy density because two electrons are produced per reaction.

The porous membrane disposed between the anode and the cathode in the conventional Zn—Br battery allows ion conduction of Zn²⁺ and Br⁻, while functioning to prevent the crossover of Br₂. Porous polyethylene membranes such as hydrophilically treated SF600 and Daramic membranes with a thickness of several hundred microns have been used taking into account the balance between ion conductivity and crossover to date. However, a thick membrane of several hundred microns was eventually used to prevent Br₂ crossover associated with porosity, resulting in an increase in membrane resistance. However, Br₂ crossover associated with porosity still acts as a factor in reducing energy efficiency.

The non-porous Nafion membrane is widely used in vanadium redox batteries and is capable of efficiently blocking bromine due to the dense polymer structure, thus being useful in Zn—Br batteries. For this reason, the non-porous Nafion membrane has higher coulombic efficiency than porous membranes, but has high membrane resistance and a low voltage efficiency. Therefore, Nafion does not havea noticeable advantage over porous membranes in terms of energy efficiency. In addition to the problem of high membrane resistance, the high cost of Nafion materials is hindering the commercialization of Zn—Br batteries.

Therefore, there is a need to develop a separator that can solve these problems.

### DISCLOSURE

### Technical Problem

Therefore, embodiments provide an amphoteric ion exchange separator for redox batteries that can maintain a high coulombic efficiency by suppressing active material crossover, improve both coulombic efficiency and voltage efficiency, which are in a trade-off relationship, and exhibits high ionic conductivity and ion selectivity, a method of manufacturing the same, and a redox battery including the same.

### Technical Solution

In accordance with one aspect of the present invention, the above and other objects can be accomplished by the provision of an amphoteric ion exchange separator for a redox battery including a polymer matrix into which a zwitterionic functional group having a quaternary ammonium group and a sulfonic acid group is introduced.

The polymer matrix may include silica into which into a zwitterionic functional group is introduced.

The silica into which the zwitterionic functional group is introduced may be present in an amount of 0.5 wt % to 4 wt % with respect to a total weight of the polymer matrix.

The polymer matrix may include at least one selected from the group consisting of perfluorosulfonic acid, polyethersulfone, polyphenylene sulfide, polyester, polyether ketone, polysulfone, polyimide, polyphenylene oxide, polyolefin, and polyethylene.

The zwitterionic functional group may be prepared from a silane monomer having an amino group and a sultone monomer.

The silane monomer having an amino group may include at least one selected from the group consisting of 3-aminopropyl)triethoxysilane, N-(2-aminoethyl)-3-(trimethoxysilyl)propylamine, N1-(3-trimethoxysilylpropyl)diethylenetriamine, bis[3-(trimethoxysilyl)propyl]amine, bis(3-(methylamino)propyl)trimethoxysilane, trimethoxy[3-(methylamino)propyl]silane, (N,N-dimethylaminopropyl)trimethoxysilane, and [3-(diethylamino)propyl]trimethoxysilane.

The sultone monomer include at least one selected from the group consisting of 1,4-butane sultone and 1,3-propane sultone.

In accordance with another aspect of the present invention, provided is a method for manufacturing a porous separator for a redox battery including preparing a zwitterionic functional group having a quaternary ammonium group and a sulfonic acid group, and introducing the zwitterionic functional group into a polymer matrix.

In the step of preparing the zwitterionic functional group, the zwitterionic functional group may be prepared by reacting a silane monomer having an amino group with a sultone monomer.

The introducing may further include reacting the zwitterionic functional group with silica to prepare silica having the zwitterionic functional group.

The preparation of the silica having the zwitterionic functional group may be carried out by hydrolyzing and condensing the zwitterionic functional group and silica, or self-condensing the zwitterionic functional group.

The introducing may be carried out by introducing the silica having the zwitterionic functional group into the polymer matrix.

The introducing may be carried out by reacting the zwitterionic functional group with the polymer matrix through hydrothermal synthesis.

In accordance with another aspect of the present invention, provided is a redox battery including an amphoteric ion exchange separator for a redox battery, wherein the amphoteric ion exchange separator includes a polymer matrix into which a zwitterionic functional group having a quaternary ammonium group and a sulfonic acid group is introduced.

The polymer matrix may include silica into which into the zwitterionic functional group is introduced.

The silica into which the zwitterionic functional group is introduced may be present in an amount of 0.5 wt % to 4 wt % with respect to a total weight of the polymer matrix.

The redox battery may be a zinc-halogen redox battery.

The redox battery may be a redox flow battery or a redox flowless battery.

### Advantageous Effects

The amphoteric ion exchange separator for redox batteries according to various embodiments has low Br₂ permeability and can secure high ion conductivity and ion selectivity. In addition, the permeate of the separator, which can indicate an amphoteric ion exchange ability, is excellent.

Therefore, a redox battery including the separator can maintain high coulombic efficiency by suppressing active material crossover, improve coulombic efficiency and voltage efficiency which are in a trade-off relationship, and maximize energy efficiency.

The redox battery of the present invention can be applied to not only flow batteries but also non-flow batteries.

### DESCRIPTION OF DRAWINGS

FIG. 1 is an SEM image and a size distribution graph showing silica (Am-Si) particles with zwitterionic functional groups and silica (Si) particles without zwitterionic functional groups.

FIG. 2 is an image showing a zinc-bromine redox flow battery to a separator according to various which embodiments of the present invention is applied.

FIG. 3 is an image showing a zinc-bromine redox flowless battery to which the separator according to various embodiments of the present invention is applied.

FIG. 4 is an image showing an experiment for measuring the Br₂ permeability of the separator in Experimental Example 2.

FIG. 5 shows the result of measurement of Br₂ permeability of the separator.

FIG. 6 shows the result of measurement of the Br₂ permeability and ion selectivity of the separator.

FIG. 7 shows the result of measurement of the permeate.

FIG. 8 shows the result of battery test of the zinc-bromine redox flow battery.

FIG. 9 shows the result of battery test of the zinc-bromine redox flowless battery.

### BEST MODE

Hereinafter, various embodiments of the disclosure will be described with reference to the attached drawings. The examples and terms used herein are not intended to limit the technology described in the disclosure to specific embodiments and should be understood to encompass various modifications or alternatives of the embodiments.

Hereinafter, embodiments of the present invention will be described in detail with reference to the attached drawings.

Various embodiments of the present invention relate to an amphoteric ion exchange separator for redox batteries. The separator in a redox battery spatially separates cathode and anode active material solutions from each other to prevent two electrolytes from being mixed and enables ionic conduction for electrochemical reactions. For electrochemical oxidation/reduction, conduction and transport of only Zn²⁺ and Br⁻ must occur inside the separator. When conduction and transport of active materials such as Br₂ and Brₙ⁻ also occur, they react with Zn, causing self-discharge. Therefore, the present invention provides a separator that is capable of smoothly transporting ions while suppressing active material cross-over.

Specifically, the amphoteric ion exchange separator for a redox battery according to various embodiments of the present invention includes a polymer matrix into which a zwitterionic functional group having a quaternary ammonium group and a sulfonic acid group is introduced.

Specifically, the zwitterionic functional group has a quaternary ammonium group and a sulfonic acid group because it is prepared from a silane monomer having an amino group and a sultone monomer.

In this case, the silane monomer having an amino group may be selected from the group consisting of 3-aminopropyl)triethoxysilane, N-(2-aminoethyl)-3-(trimethoxysilyl)propylamine, N1-(3-trimethoxysilylpropyl)diethylenetriamine, bis[3-(trimethoxysilyl)propyl]amine, bis(3-(methylamino)propyl)trimethoxysilane, trimethoxy[3-(methylamino)propyl]silane, (N,N-dimethylaminopropyl)trimethoxysilane, and [3-(diethylamino)propyl]trimethoxysilane.

The sultone monomer may be selected from the group consisting of 1,4-butane sultone and 1,3-propane sultone.

For example, the zwitterionic functional group may be prepared through the reaction of (3-amipropyl)triethoxysilane and 1,3-propane sultone. At this time, the zwitterionic functional group may be prepared through the following reaction scheme and may have a quaternary ammonium group and a sulfonic acid group.

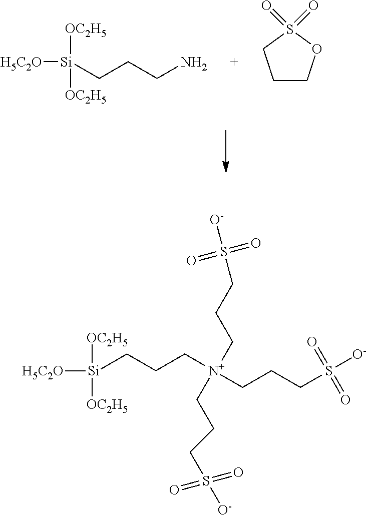

The quaternary ammonium group can conduct Br-and at the same time, capture bromine generated during charging, thus having both high coulombic efficiency and excellent voltage efficiency. In addition, the zwitterionic functional group has not only a quaternary ammonium group but also a sulfonic acid group and thus zwitterions are homogeneously present in the separator when applied to the separator in the subsequent process.

The zwitterionic functional group may be introduced into the polymer matrix. The polymer matrix may include at least one selected from the group consisting of perfluorosulfonic acid, polyethersulfone, polyphenylene sulfide, polyester, polyether ketone, polysulfone, polyimide, polyphenylene oxide, polyolefin, and polyethylene.

According to one embodiment, the zwitterionic functional group may be introduced into silica and the silica into which the zwitterionic functional group is introduced may be introduced into a polymer matrix. In this case, the polymer matrix may be perfluorosulfonic acid. The silica into which the zwitterionic functional group is introduced may be present in an amount of 0.5 wt % to 4 wt % based on the total weight of the polymer matrix. Preferably, the silica into which the zwitterionic functional group is introduced may be present in an amount of 1.0 wt % to 2.0 wt % based on the total weight of the polymer matrix. This weight ratio suppresses the Br₂ permeability of the separator while improving ion conductivity and ion selectivity. In addition, cations and anions can move simultaneously, resulting in excellent amphoteric ion exchange ability. Meanwhile, this separator may be applied to a zinc-bromine redox flow battery.

Meanwhile, according to another embodiment, the zwitterionic functional group may be directly introduced into the polymer matrix. In this case, the polymer matrix may be polyethylene. That is, the polymer matrix contains silica and the zwitterionic functional group is introduced through a hydrothermal synthesis method, so that a separator having the zwitterionic functional group can be manufactured. For example, the zwitterionic functional group may be introduced at 10 wt % to 50 wto based on the weight of the polymer matrix. Meanwhile, this separator may be applied to a zinc-bromine redox flowless battery.

The porous separator for redox batteries according to various embodiments of the present invention has low Br₂ permeability and can secure high ion conductivity and ion selectivity. In addition, the permeate of the separator, which can indicate the zwitterionic exchange ability, is excellent.

The redox battery to which the separator according to various embodiments of the present invention is applied can improve both coulombic efficiency and voltage efficiency, which are in a trade-off relationship, and maximize energy efficiency.

Hereinafter, a method for manufacturing a porous separator for a redox battery according to various embodiments of the present invention will be described.

The method of manufacturing a porous separator for a redox battery according to various embodiments of the present invention includes preparing a zwitterionic functional group having a quaternary ammonium group and a sulfonic acid group, and introducing the zwitterionic functional group into a polymer matrix.

First, in the step of preparing the zwitterionic functional group, the zwitterionic functional group may be prepared by reacting a silane monomer having an amino group with a sultone monomer. The silane monomer having an amino group may be selected from the group consisting of 3-aminopropyl)triethoxysilane, N-(2-aminoethyl)-3-(trimethoxysilyl)propylamine, N1-(3-trimethoxysilylpropyl)diethylenetriamine, bis[3-(trimethoxysilyl)propyl]amine, bis(3-(methylamino)propyl)trimethoxysilane, trimethoxy[3-(methylamino)propyl]silane, (N,N-dimethylaminopropyl)trimethoxysilane, and [3-(diethylamino)propyl]trimethoxysilane.

The sultone monomer may be selected from the group consisting of 1,4-butane sultone and 1,3-propane sultone.

The silane monomer having such an amino group and the sultone monomer may be mixed at a weight ratio of 1:1 in the presence of a solvent and reacted in a nitrogen atmosphere and at a temperature of 40° C. to 60° C. After reaction, the solvent may be dried.

Next, the step of introducing the zwitterionic functional group into the polymer matrix may be performed. According to one embodiment, the zwitterionic functional group may first be introduced into silica and then the silica into which the zwitterionic functional group is introduced may be introduced into the polymer matrix. Specifically, the zwitterionic functional group and silica may be hydrolyzed and condensed, or only the zwitterionic functional group may be self-condensed at a pH of 2 or lower.

For example, silica having a diameter of 200 to 300 nm derived from tetraethyl orthosilicate and a zwitterionic functional group may be mixed at a weight ratio of 1:1 in a solvent and reacted in a nitrogen atmosphere at 90 to 130° C. As a result, the zwitterionic functional group may be bonded to the silica surface. The silica and the zwitterionic functional group may be bonded at a weight ratio of 1:1. In this case, the average diameter of the silica into which the zwitterionic functional group is introduced may be 400 nm to 500 nm. Then, silica into which the zwitterionic functional group is introduced may be mixed with a polymer matrix in an amount of 0.5 wt % to 4 wt % based on the weight of the polymer matrix solid, followed by thermal treatment to manufacture a separator.

Meanwhile, according to another embodiment, the zwitterionic functional group may be directly introduced into the polymer matrix. For example, a commercial porous separator containing silica is reacted at a temperature of 90° C. to 110° C. using a hydrothermal synthesizer to allow water to easily permeate the porous separator, and the zwitterion functional group is dissolved in distilled water and then mixed in an amount of 10 wt % to 50 wt % with respect to the weight of the separator. A solution containing a swollen separator and a zwitterionic functional group may be reacted at a temperature of 90° C. to 110° C. using a hydrothermal synthesizer and the remaining zwitterionic functional group may be removed to manufacture a separator.

Various embodiments of the present invention provide a redox battery including the porous separator for a redox battery. In this case, the redox battery may be a zinc-halogen redox battery. In addition, the redox battery may be a redox flow battery or a redox flowless battery.

For example, the redox flow battery may include a cell, a tank, and a pump. The cell may include an end plate, a current collector, a bipolar plate, an anode, a cathode, and a separator. The separator may be the porous separator for redox batteries described above. Specifically, the separator may include a polymer matrix containing silica into which a zwitterion functional group is introduced. The separator is interposed between the cathode and the anode and the cathode and the anode may include carbon felt.

The bipolar plate has a plurality of holes and an electrolyte solution can pass through the holes. The bipolar plate may contact the electrodes.

The current collector is a passage through which electrons move and functions to accept electrons from the outside upon charging or to discharge the electrons to the outside upon discharging. The current collector may be a conductive metal plate made of copper or brass. The current collector may have a plurality of holes and the electrolyte solution may pass through the holes.

The end plate may be provided on the outermost side and may be provided with a plurality of holes that serve as passages through which the electrolyte is injected and discharged. The holes in the end plate may be communicated with the tank.

The tank may include a cathode electrolyte tank and an anode electrolyte tank. The tank may accommodate the electrolyte and may be connected to a pump. The electrolyte solution discharged from the tank may be injected into the cell by the operation of the pump.

Meanwhile, the redox flowless battery is a system in which the tank and pump are removed from the previously described redox flow battery and may store bromine in the cell. At this time, in the redox flow battery, the anode may include zinc metal and the cathode may include carbon felt. The porous separator for a redox battery described above may be interposed between the anode and the cathode. Specifically, the separator may be a separator in which a zwitterion functional group is introduced into a polymer matrix through hydrothermal synthesis.

Hereinafter, the present disclosure will be described with reference to examples in detail. However, the examples according to the present disclosure may be modified into various other forms and should not be construed as limiting the scope of the present disclosure. The examples of the disclosure are provided to more completely explain the present disclosure to those skilled in the art.

### EXAMPLE 1: PREPARATION OF ZWITTERIONIC FUNCTIONAL GROUPS

(3-amipropyl)triethoxysilane and 1,3-propane sultone were reacted at a weight ratio of 1:1 using tetrahydrofuran (THF) as a solvent in a nitrogen atmosphere at 50° C. for 2 hours. After reaction, the solvent was dried in a vacuum oven at 45° C. for 24 hours or longer.

Meanwhile, the reaction scheme according to Example 1 is as follows.

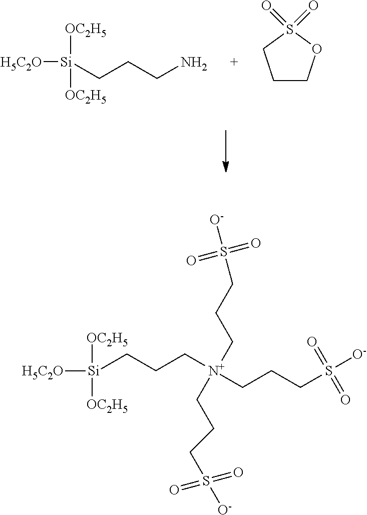

### EXAMPLE 2-1: PREPARATION OF SILICA WITH ZWITTERIONIC FUNCTIONAL GROUP INTRODUCED

The zwitterionic functional group prepared according to Example 1 and silica were reacted in a weight ratio of 1:1 in the presence of toluene as a solvent in a nitrogen atmosphere at 110° C. for 5 hours. The silica was derived from tetraethyl orthosilicate and had a size of 200 to 300 nm. In addition, it could be seen through TGA that the silica and zwitterionic functional group on the surface were bound at a weight ratio of 1:1.

### EXAMPLE 2-2: PREPARATION OF POLYMER MATRIX CONTAINING SILICA INTO WHICH THE ZWITTERIONIC FUNCTIONAL GROUP IS INTRODUCED

Zwitterionic silica was mixed by stirring with Nafion from DuPont, which is a perfluorosulfonic acid (PFSA) polymer, as a polymer matrix, in an amount of 1.0% to 3.5% with respect to the solid weight of the Nafion. The mixed solution was heat-treated in a vacuum oven and at the same time, the solvent was evaporated to obtain a separator.

Meanwhile, SF600 as a commercial porous membrane, NRE-212 as a commercial ion exchange membrane from DuPont, and Nafion-Si, which contains silica without any functional groups around the silica, were used for comparison of results. At this time, pure Si was used at 0.75 wt % in Nafion-Si. Nafion-Am.Si 1.0, Nafion-Am.Si 1.5, and Nafion-Am.Si 2.0 were used at 1.0, 1.5, and 2.0 wt % to optimize the amount of zwitterionic silica to be introduced into Nafion.

[Correction pursuant to Rule 91 on 02.11.2022]

[Correction pursuant to Rule 91 on 02.11.2022]

### EXAMPLE 3: PREPARATION OF POLYMER MATRIX WITH ZWITTERIONIC FUNCTIONAL GROUP INTRODUCED

SF600 from Asahi is a commercial porous separator used in batteries and contains silica. The zwitterionic functional group was reacted with SF600 by hydrothermal synthesis to prepare a porous membrane with a zwitterionic functional group.

The reaction was performed in a hydrothermal synthesizer at 100° C. for 1 hour so that water can penetrate SF600 well. The zwitterionic functional group was dissolved in distilled water to prepare a reaction solution. At this time, the weight of the zwitterionic functional group corresponds to ½ times the amount of SF600 to be reacted.

The solution containing the swollen SF600 and the zwitterionic functional group was reacted in a hydrothermal synthesizer at 100° C. for 8 hours and was washed several times with distilled water to remove the remaining zwitterionic functional group.

[Correction pursuant to Rule 91 on 02.11.2022]

[Correction pursuant to Rule 91 on 02.11.2022]

### EXAMPLE 4: PREPARATION OF ZINC-BROMINE REDOX FLOW BATTERY

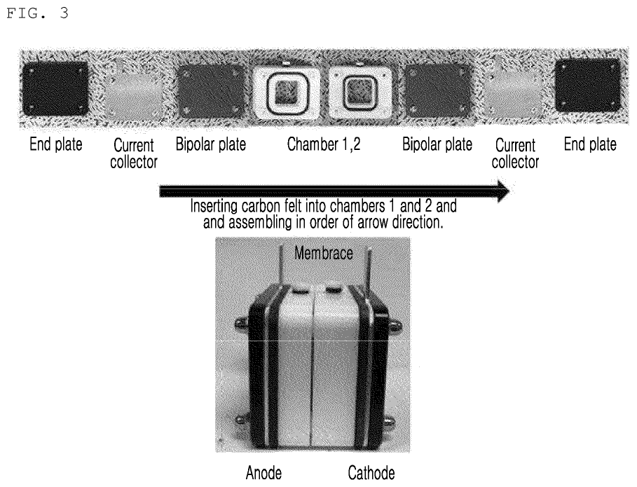

Referring to FIG. 2, the zinc-bromine redox flow battery consists of a measurement cell, two aqueous tanks, and a pump. A total of 40 mL of an electrolyte was used, 20 mL each for the anode and the cathode, and the flow rate of the electrolyte was 50 mL/min.

The cell for measuring battery performance consists of an end plate, a current collector, a bipolar plate, carbon felt, and a membrane. The carbon felt used herein was 4.6 mm carbon felt for both the anode and the cathode, and had an active area of 6 cm².

2.25 M ZnBr₂ was used as the electrolyte and neither conductive agent nor complexing agent were used. Charging and discharging were carried out at a current density of 20 mA/cm², constant current charging was performed to adjust the state of charge (SoC) to 10%, and discharging was performed to 0.01 V.

### EXAMPLE 5: PREPARATION OF ZINC-BROMINE REDOX FLOWLESS BATTERY

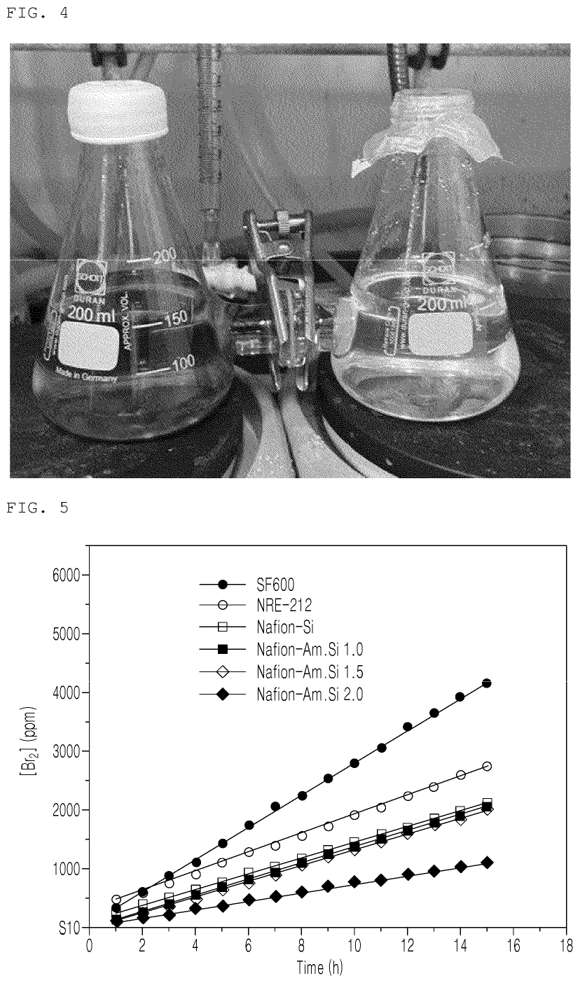

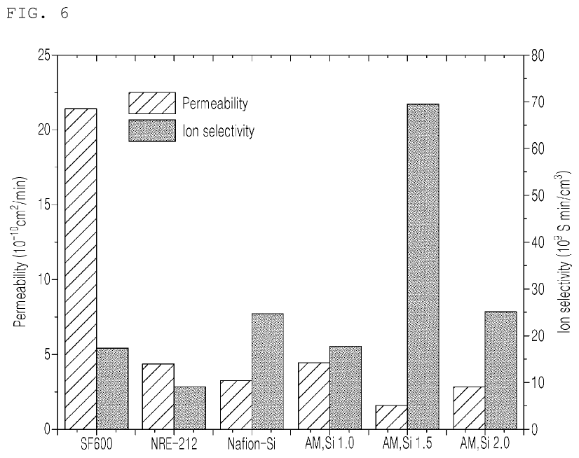

Referring to FIG. 3, the active area of the flowless battery was 3.92 cm², a zinc metal was used as the anode, and 4.6 mm carbon felt was used as the cathode. 2.5 M ZnBr₂ was used as the electrolyte and neither conductive agent nor complexing agent were used. Charging and discharging were carried out at a current density of 20 mA/cm², constant current charging was performed to adjust a state of charge (SoC) to 20%, and discharging was performed to 0.01 V.

### EXPERIMENTAL EXAMPLE 1: CONFIRMATION OF SIZE DISTRIBUTION OF SILICA WITH ZWITTERIONIC FUNCTIONAL GROUP INTRODUCED

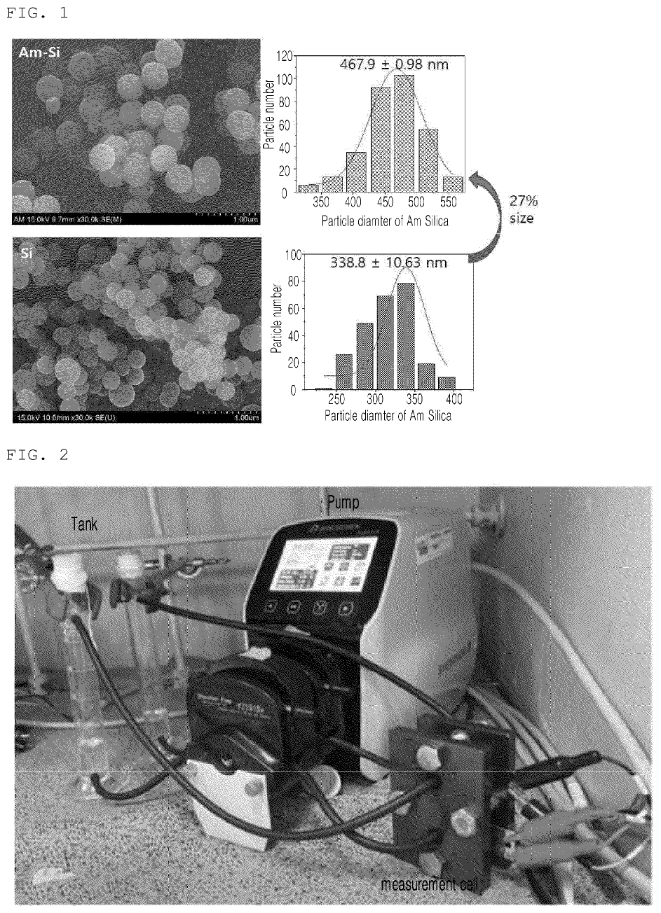

The size distribution of silica (Am-Si) particles with a zwitterionic functional group introduced and silica (Si) particles without a zwitterionic functional group according to Example 2-1 were confirmed. As a result, as can be seen from FIG. 1, the silica (Am-Si) into which a zwitterionic functional group was introduced had an average size of 467.9±0.98 nm, whereas the silica (Si) without a zwitterionic ionic functional group had an average size of 338.8±10.63 nm. In other words, it can be seen that the size increased by about 27% by functionalizing the silica surface with the zwitterionic functional group.

### EXPERIMENTAL EXAMPLE 2: MEASUREMENT OF BR₂ PERMEABILITY, IONIC CONDUCTIVITY AND ION SELECTIVITY

The separator according to Example 2-2 was placed and fastened between H-shaped cells, and then 0.2 M Br₂, 2.25 M ZnBr₂ and 0.5 M ZnCl₂ were injected in an amount of 150 mL on one side, and 2.25 M ZnBr₂ and 0.5 M ZnCl₂ were injected without Br₂ in an amount of 150 mL on the other side. Then, the solution was collected every hour from the solution reservoir not containing Br₂ while stirring and the Br₂ concentration was measured using a UV-vis spectrometer.

The permeability of Br₂ of the separator was calculated using the concentration of Br₂ (C_{R}(t)) permeated over 6 hours. Specifically, the permeability was calculated according to the following equation.

$$P = \frac{L {V}_{R}}{a {C}_{L}} \frac{{C}_{R} ( t )}{t}$$

wherein L is the thickness of the membrane, A is the area of the cell (6 cm²), V_{R} is the volume of the solution (UV-vis measurement side), C_{L} is the total concentration of Br₂, and t is time (calculated based on the result for 6 hours in this experiment).

Meanwhile, the ionic conductivity of the separator was measured through the area specific resistance (ASR) of the membrane, and was obtained using an electrochemical impedance analyzer within the frequency range of 1 Hz to 100 kHz at an amplitude of 10 mV. The ASR was obtained from the following equation:

$$ASR = A \times ( r 1 - r 2 )$$

wherein r2 is the resistance of the cell measured without a separator and r1 is the resistance measured by applying the separator to be measured to the cell. A corresponds to the active area of 6 cm². 20 mL of an electrolyte is used in each tank and consists of 0.2 M Br₂, 2.25 M ZnBr₂, and 0.5 M ZnCl₂. The flow rate of electrolyte solution is 50 mL/min. The ionic conductivity of the separator was obtained by dividing the membrane thickness by ASR.

The high ionic conductivity and low active material crossover of the separator are very important in the operation of ZBB and the following equation expresses ion selectivity using ionic conductivity and Br₂ permeability.

$$S = \frac{δ}{P}$$

wherein S is the ion selectivity, δ is the ionic conductivity, and P is the Br₂ permeability.

Meanwhile, the characteristics of the separators used in Experimental Example 2, namely, SF600, NRE-212, Nafion-Si, Nafion-Am Si 1.0, Nafion-Am Si 1.5, and Nafion-Am Si 2.0, are shown in Table 1 below.

TABLE 1

| | | | Content of |
|---|---|---|---|
| | | Thickness | additive |
| Separator | Material | (μm) | (wt %) |
| SF600 | Porous PE membrane | 600 | 50 |
| | containing silica | | |
| NRE-212 | PESA | 50 | 0 |
| Nafion-Si | PFSA with introduced | 50 | 0.75 |
| | silica | | |
| Nafion-Am | PFSA with introduced | 50 | 1.0 |
| Si 1.0 | zwitterionic exchange | | |
| | silica | | |
| Nafion-Am | PFSA with introduced | 50 | 1.5 |
| Si 1.5 | zwitterionic exchange | | |
| | silica | | |
| Nafion-Am | PFSA with introduced | 50 | 2.0 |
| Si 2.0 | zwitterionic exchange | | |
| | silica | | |

The results of measurement of Br₂ permeability, ion conductivity, and ion selectivity are shown in Table 2 below. As can be seen from FIG. 5 and Table 2 below, the results of measurement of Br₂ permeability show that SF600 having porosity had the highest Br₂ permeability, and NRE-212,Nafion-Si, and Nafion-Am.Si decreased in that order. Thereamong, Nafion-Am.Si 1.5 exhibited the lowest transmittance.

TABLE 2

| | | | | Ion |
|---|---|---|---|---|
| | C_{R} (t) | Ion | Br₂ permeability | selectivity |
| | (10⁸ mol/L) | conductivity | (P) | (10⁹ S |
| Separator | at 6 h | δ (S/cm) | (10⁻¹⁰ cm²/min) | min/cm³) |
| SF600 | 3.42 | 10.18 | 5.97 | 17.14 |
| NRE-212 | 2.51 | 3.84 | 4.36 | 8.80 |
| Nafion-Si | 1.83 | 7.78 | 3.17 | 24.61 |
| Nafion-Am | 1.46 | 4.41 | 2.53 | 17.43 |
| Si 1.0 | | | | |
| Nafion-Am | 0.91 | 11.05 | 1.58 | 69.94 |
| Si 1.5 | | | | |
| Nafion-Am | 1.60 | 7.00 | 2.78 | 25.18 |
| Si 2.0 | | | | |

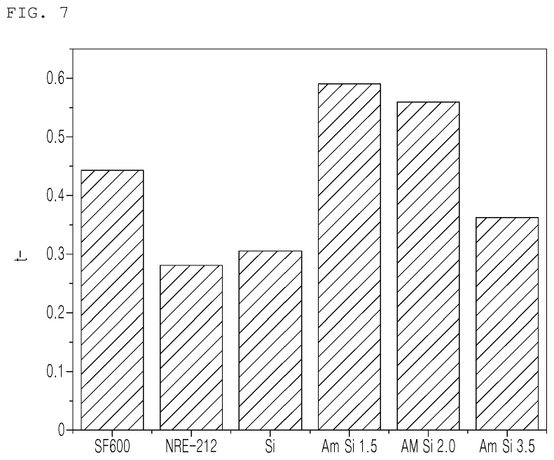

As can be seen from Table 2 above, the result of measurement of the ionic conductivity shows that Nafion-Am Si 1.5 had better ionic conductivity than SF600, which has high ionic conductivity due to porosity. Meanwhile, as can be seen from FIG. 6 and Table 2, Nafion-Am Si 1.5, which had the highest ion conductivity and the lowest Br₂permeability, had the highest ion selectivity. In other words, it was found that the optimal addition amount of zwitterionic silica (additive) was 1.5 wt % and additional experiments such as battery evaluation were conducted using Nafion-Am Si 1.5.

### EXPERIMENTAL EXAMPLE 3: MEASUREMENT OF PERMEATE

The amphoteric ion exchange ability that allows Zn²⁺ and Br⁻ to move simultaneously through the separator can be confirmed by measuring the permeate of the separator.

The permeate of the separator was determined by measuring the liquid junction potential through an H-shaped cell using Ag/AgCl filled with 3 M NaCl as a reference electrode. A 0.01 M ZnBr₂ solution and a 0.6 M ZnBr₂ solution were injected into the left and right chambers, respectively, of the H-cell, respectively. The 3 M NaCl Ag/AgCl reference electrode was placed in each chamber and the open circuit voltage (OCV) was measured. The permeate was calculated using the following equation from the measured OCV value.

$$\begin{matrix}{E}_{j} = \text{?} - \text{?} = - \frac{RT}{F} {\sum }_{i} \int \text{?} \text{?} \frac{{t}_{i}}{\text{?}} \\ {t}_{+} + {t}_{-} = 1 ,\end{matrix} \text{?} ,$$

$$\text{?} \text{indicates text missing or illegible when filed}$$

wherein Eᵢ is a liquid junction potential (OCV), T is a temperature, F is a Faraday constant, tᵢ is an ion permeate, aᵢ is an ion activity, α is 0.01, and β is 0.6.

t_ was determined by calculating the permeability for Br⁻ (an anion) using the measured OCV. If only cations are exchangeable, t_ becomes 0.

The results are shown in Table 3 below.

TABLE 3

| Separator | t_{—} |
|---|---|
| SF600 | 0.44 |
| NRE-212 | 0.28 |
| Nafion-Si | 0.30 |
| Nafion-Am Si 1.5 | 0.59 |
| Nafion-Am Si 2.0 | 0.55 |
| Nafion-Am Si 2.5 | 0.53 |
| Nafion-Am Si 3.5 | 0.36 |

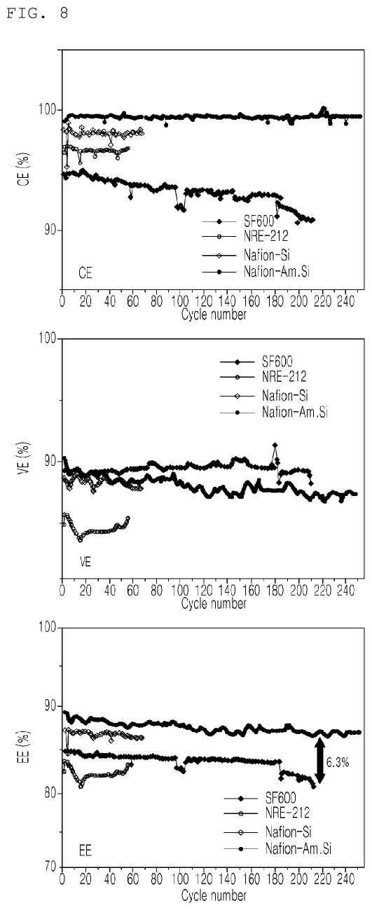

As can be seen from FIG. 7 and Table 3, SF600, which has porosity that allows all ions to pass through, had a t_ value of 0.44, meaning that the transport of anion and cations is balanced. NRE-212, which has only a cation exchanger, had the lowest t_, and similarly, Nafion-Si had the next lowest t_.

Nafion-Am Si, into which a zwitterionic exchange group was introduced, had balance like SF600. Thereamong, Nafion-Am Si 1.5 had the best permeability. Meanwhile, it can be seen that t_ decreases as the amount of zwitterionic silica increases. This is considered because one N⁺ and three SO³⁻ are bound to the zwitterionic exchange functional group, so that the proportion of SO³⁻ groups that can be transported by the cation increases as the amount of additive increases.

### EXPERIMENTAL EXAMPLE 4: BATTERY EVALUATION OF ZINC-BROMINE REDOX FLOW BATTERY

As can be seen from the previous Experimental Examples 2 and 3, the optimal addition amount of zwitterionic silica (additive) was 1.5 wt %, and a battery evaluation experiment was conducted using Nafion-Am Si 1.5. For battery evaluation, coulombic efficiency (CE), voltage efficiency (VE), and cycling efficiency including energy efficiency (EE) were determined by the following equation.

$$\begin{matrix}Coulombic Efficiency : CE = Charge Capacity / Discharge Capacity \\ Voltage efficiency : VE = average cell voltage upon charging / average cell voltage upon discharging \\ Energy efficiency : EE = CE \times VE\end{matrix}$$

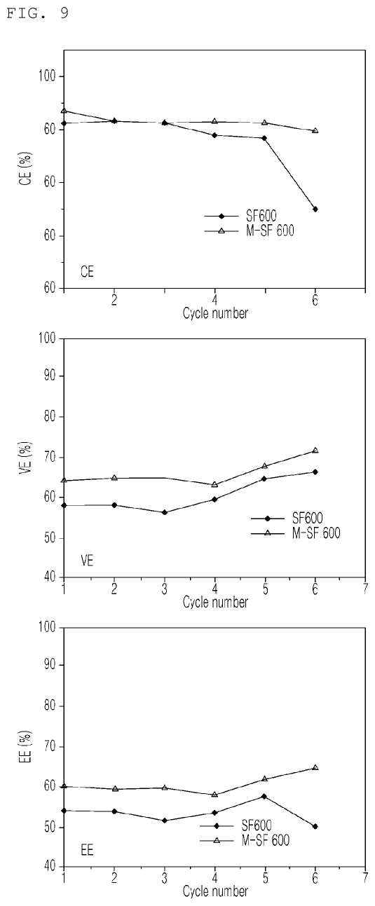

As can be seen from FIG. 8, the result of the battery evaluation of the flow battery showed that Nafion-Am Si had a CE close to 100% and maintained a stable CE even upon battery evaluation over 200 cycles. Meanwhile, SF600 had a rapidly decreased CE.

In addition, SF600 exhibited a slight increase in VE over cycles. This is because self-discharge occurs due to active material crossover, the voltage difference between the anode and cathode is reduced, and VE was slightly increased along with the reduced CE. Meanwhile, it can be seen that the Nafion-Am Si of the present invention exhibits an increase in both CE and VE.

The energy efficiency was compared between respective separators. The result showed that Nafion Am Si had the best EE. In particular, Nafion Am Si had an energy efficiency of 88.42%, which is 7% higher than the commercial NRE-212 and is about 6.3% higher than the commercial SF600.

EXPERIMENTAL EXAMPLE 5: BATTERY EVALUATION OF ZINC-BROMINE REDOX FLOWLESS BATTERY

As in Experimental Example 4, the flowless battery was evaluated. Battery evaluation of the flowless battery was conducted on commercial SF600 and the separator according to Example 3. The separator according to Example 3, which had silica surface of SF600 improved with zwitterionic functional groups, was referred to as “M-SF600”.

The results are shown in FIG. 9 and Table 4 below.

TABLE 4

| | |
|---|---|
| SF600 | M-SF600 |

| | 1^{st} | 6^{th} | 1^{st} | 6^{th} |
|---|---|---|---|---|
| CE | 91.31 | 75.08 | 93.41 | 89.71 |
| VE | 58.88 | 66.43 | 64.33 | 71.86 |
| EE | 53.76 | 49.88 | 60.09 | 64.46 |

As can be seen from FIG. 9 and Table 4, SF600 had a rapid decrease in CE after the 5^{th} cycle. This is considered due to electrolyte depletion resulting from the release of Br₂ gas generated during charging and self-discharge resulting from active material crossover. On the other hand, M-SF600 according to Example 3 had stable CE, unlike SF600 having a rapid decrease in CE. In particular, CE was found to be approximately 15% higher than that of SF600 at the 6^{th} cycle. This is considered because the zwitterionic exchange functional group captured Br₂, preventing active material crossover. In addition, it is considered the zwitterionic exchange functional group captured Br₂ and acted as a complexing agent to prevent vaporized Br₂ from being released and thereby prevent a decrease in electrolyte capacity.

In addition, it was found that addition of zwitterionic exchange groups to the separator imparts higher ionic conductivity than SF600 to the separator and thereby imparts a higher VE thereto. By simultaneously improving CE and VE, which act as a trade-off, EE was greatly improved.

The features, structures, effects and the like described in the embodiments above are included in one or more embodiments of the present invention and are not necessarily limited to only one embodiment. Furthermore, the features, structures, effects, and the like illustrated in each embodiment may be combined or modified in other embodiments by those having ordinary knowledge in the field to which the embodiments pertain. Therefore, such combinations and modifications should be construed as falling within the scope of the present invention.

Although the present invention has been be described in more detail with reference to specific embodiments, the embodiments are provided only for illustration and thus should not be construed as limiting the scope of the present invention. Those skilled in the art will appreciate that various modifications, additions and substitutions are possible, without departing from the scope and spirit of the invention as disclosed in the accompanying claims. For example, each component specifically disclosed in the embodiments may be modified. In addition, these differences relating to modifications and applications should be construed as falling within the scope of the present invention as defined in the appended claims.

### INDUSTRIAL APPLICABILITY

The present invention relates to an amphoteric ion exchange separator for a Zn—Br redox battery that is capable of transporting both cations and anions, and suppressing active material crossover through a zwitterionic functional group including a quaternary ammonium group and a sulfonic acid group, and thus simultaneously solving the problems of coulombic efficiency and voltage efficiency, thereby being highly industrially applicable.

1. An amphoteric ion exchange separator for a redox battery comprising a polymer matrix into which a zwitterionic functional group having a quaternary ammonium group and a sulfonic acid group is introduced.

2. The amphoteric ion exchange separator according to claim 1, wherein the polymer matrix comprises silica into which into a zwitterionic functional group is introduced.

3. The amphoteric ion exchange separator according to claim 2, wherein the silica into which the zwitterionic functional group is introduced is present in an amount of 0.5 wt % to 4 wt % with respect to a total weight of the polymer matrix.

4. The amphoteric ion exchange separator according to claim 1, wherein the polymer matrix comprises at least one selected from the group consisting of perfluorosulfonic acid, polyethersulfone, polyphenylene sulfide, polyester, polyether ketone, polysulfone, polyimide, polyphenylene oxide, polyolefin, and polyethylene.

5. The amphoteric ion exchange separator according to claim 1, wherein the zwitterionic functional group is prepared from a silane monomer having an amino group and a sultone monomer.

6. The amphoteric ion exchange separator according to claim 5, wherein the silane monomer having an amino group comprises at least one selected from the group consisting of 3-aminopropyl)triethoxysilane, N-(2-aminoethyl)-3-(trimethoxysilyl)propylamine, N1-(3-trimethoxysilylpropyl) diethylenetriamine, bis[3-(trimethoxysilyl)propyl]amine, bis(3-(methylamino)propyl)trimethoxysilane, trimethoxy[3-(methylamino)propyl]silane, (N,N-dimethylaminopropyl)trimethoxysilane, and [3-(diethylamino)propyl]trimethoxysilane.

7. The amphoteric ion exchange separator according to claim 5, wherein the sultone monomer comprises at least one selected from the group consisting of 1,4-butane sultone and 1,3-propane sultone.

8. A method for manufacturing a porous separator for a redox battery comprising:
preparing a zwitterionic functional group having a quaternary ammonium group and a sulfonic acid group; and
introducing the zwitterionic functional group into a polymer matrix.

9. The method according to claim 8, wherein, in the step of preparing the zwitterionic functional group, the zwitterionic functional group is prepared by reacting a silane monomer having an amino group with a sultone monomer.

10. The method according to claim 9, wherein the silane monomer having an amino group comprises at least one selected from the group consisting of 3-aminopropyl)triethoxysilane, N-(2-aminoethyl)-3-(trimethoxysilyl)propylamine, N1-(3-trimethoxysilylpropyl)diethylenetriamine, bis[3-(trimethoxysilyl)propyl]amine, bis(3-(methylamino)propyl)trimethoxysilane, trimethoxy[3-(methylamino)propyl]silane, (N,N-dimethylaminopropyl)trimethoxysilane, and [3-(diethylamino)propyl]trimethoxysilane.

11. The method according to claim 9, wherein the sultone monomer comprises at least one selected from the group consisting of 1,4-butane sultone and 1,3-propane sultone.

12. The method according to claim 8, wherein the introducing the zwitterionic functional group further comprises reacting the zwitterionic functional group with silica to prepare silica having the zwitterionic functional group.

13. The method according to claim 12, wherein the preparation of the silica having the zwitterionic functional group is carried out by hydrolyzing and condensing the zwitterionic functional group and silica, or self-condensing the zwitterionic functional group.

14. The method according to claim 12, wherein the introducing is carried out by introducing the silica having the zwitterionic functional group into the polymer matrix.

15. The method according to claim 8, wherein the introducing is carried out by reacting the zwitterionic functional group with the polymer matrix through hydrothermal synthesis.

16. A redox battery comprising an amphoteric ion exchange separator for a redox battery,
wherein the amphoteric ion exchange separator comprises a polymer matrix into which a zwitterionic functional group having a quaternary ammonium group and a sulfonic acid group is introduced.

17. The redox battery according to claim 16, wherein the polymer matrix comprises silica into which into the zwitterionic functional group is introduced.

18. The redox battery according to claim 17, wherein the silica into which the zwitterionic functional group is introduced is present in an amount of 0.5 wt % to 4 wt % with respect to a total weight of the polymer matrix.

19. The redox battery according to claim 16, wherein the polymer matrix comprises at least one selected from the group consisting of perfluorosulfonic acid, polyethersulfone, polyphenylene sulfide, polyester, polyether ketone, polysulfone, polyimide, polyphenylene oxide, polyolefin, and polyethylene.

20. The redox battery according to claim 16, wherein the redox battery is a zinc-halogen redox battery.

21. (canceled)
